(19) United States
(12) Patent Application Publication
(10) Pub. No.: US 2015/0201182 A1
(43) Pub. Date: Jul. 16, 2015

(54) AUTO FOCUS METHOD AND AUTO FOCUS APPARATUS

(71) Applicant: Altek Semiconductor Corp., Hsinchu City (TW)

(72) Inventors: Wen-Yan Chang, Miaoli County (TW); Yu-Chen Huang, Hsinchu County (TW); Hong-Long Chou, Hsinchu County (TW); Chung-Chia Kang, Tainan City (TW); Shan-Lung Chao, Hsinchu City (TW)

(21) Appl. No.: 14/670,419

(22) Filed: Mar. 27, 2015

Related U.S. Application Data
(63) Continuation-in-part of application No. 13/899,586, filed on May 22, 2013.

(30) Foreign Application Priority Data
Apr. 11, 2013 (TW) 102112875

(51) Int. Cl. H04N 13/02; H04N 5/232

(52) U.S. Cl. CPC H04N 13/0271; H04N 13/0239; H04N 5/23212; H04N 2013/0081

(57) ABSTRACT

An auto focus (AF) method adapted to an AF apparatus is provided. The AF method includes following steps. A first image is captured by using the first image sensor. At least one characteristic is detected based on the first image, and whether the characteristic meets a predetermined condition is determined. If the characteristic meets the predetermined condition, a focus depth is calculated according to a three-dimensional (3D) depth information and movement of a first lens of the first sensor is driven according to the focus depth for focusing. If the characteristic does not meet the predetermined condition, the first lens is driven to move for many times to obtain a plurality of contrast values, such that movement of the first lens is driven according to the contrast values for focusing. Additionally, an AF apparatus is provided.

### CROSS-REFERENCE TO RELATED APPLICATION

This application is a continuation-in-part application of and claims the priority benefit of U.S. application Ser. No. 13/899,586, filed on May. 22, 2013, now pending, which claims the priority benefit of Taiwan application Ser. No. 102112875, filed on Apr. 11, 2013. The entirety of each of the above-mentioned patent applications is hereby incorporated by reference herein and made a part of this specification.

### BACKGROUND

1. Technique Field

The disclosure generally relates to an auto focus (AF) technique, and more particularly, to an AF method and an AF apparatus adopting a stereoscopic image processing technique.

2. Description of Related Art

A digital camera usually has a very complicated mechanical structure and enhanced functionality and operability. Besides the user's photographing skill and the surrounding environment, the auto focus (AF) system in a digital camera also has a great impact on the quality of images captured by the digital camera.

Generally, an AF technique refers to that a digital camera moves its lens to change the distance between the lens and an object to be photographed and repeatedly calculates a focus evaluation value (referred to as a focus value thereinafter) of the captured image according to the position of the lens until the maximum focus value is determined. To be specific, the maximum focus value of a lens allows a clearest image of the object to be photographed at the current position of the lens. However, in the hill-climbing technique or regression technique adopted by existing AF techniques, every focusing action requires the lens to be continuously moved and multiple images to be captured to search for the maximum focus value. Thus, it is very time-consuming. Besides, when a digital camera moves its lens, the lens may be moved too much therefore has to be moved back and forth. As a result, a phenomenon named “Breathing” may be produced. The phenomenon of breathing refers to the change of angle of view of a lens when shifting the focus and therefore destroys the stability of the image.

On the other hand, an AF technique adopting the stereoscopic vision technique for processing images and establishing image three-dimensional (3D) depth information is provided. This AF technique can effectively shorten the focusing time and eliminate the phenomenon of breathing and can increase the focusing speed and image stability therefore becomes increasingly popular in related fields. However, generally speaking, when 3D coordinate position information of each pixel in an image is obtained through image processing of the present stereoscopic vision technique, the position of each point in the image cannot be determined precisely. Since it is difficult to identify relative depth or precisely determine depth information of each point in a texture-less or flat area, “holes” may be produced in the 3D depth map. Besides, if this AF technique is applied to a handheld electronic apparatus (for example, a smart phone), to minimize the size of the product, the stereo baseline of the product has to be reduced as much as possible. As a result, precise positioning may become even more difficult and more holes may be produced in the 3D depth map. Moreover, the execution of subsequent image focusing procedures may be affected.

### SUMMARY

Accordingly, the disclosure is directed to an auto focus (AF) method and an AF apparatus which offer fast focusing speed and optimal image stability.

The disclosure provides an AF method adapted to an AF apparatus. The AF apparatus includes a first image sensor and a second image sensor. The AF method includes following steps. A target object is selected and photographed by the first image sensor and the second image sensor to generate a first image and a second image. A three-dimensional (3D) depth estimation is performed according to the first image and the second image to generate a 3D depth map. An optimization process is performed on the 3D depth map to generate an optimized 3D depth map. A piece of depth information corresponding to the target object is determined according to the optimized 3D depth map, and a focusing position regarding the target object is obtained according to the piece of depth information. The AF apparatus is driven to execute an AF procedure according to the focusing position.

The disclosure provides an AF apparatus including a first image sensor, a second image sensor, a focusing position control module, and a processing unit. The first image sensor and the second image sensor photograph a target object to generate a first image and a second image. The focusing position control module controls a focusing position of the first image sensor and the second image sensor. The processing unit is coupled to the first image sensor, the second image sensor, and the focusing position control module. The processing unit performs a procedure of 3D depth estimation on the first image and the second image to generate a 3D depth map and performs an optimization process on the 3D depth map to generate an optimized 3D depth map. The processing unit determines a piece of depth information corresponding to the target object according to the optimized 3D depth map and obtains the focusing position regarding the target object according to the piece of depth information. The focusing position control module executes an AF procedure according to the focusing position.

The disclosure provides an auto focus (AF) method, adapted to an AF apparatus, wherein the AF apparatus includes a first image sensor and a second image sensor, and the AF method includes following steps. A first image is captured by using the first image sensor. At least one characteristic is detected based on the first image, and whether the characteristic meets a predetermined condition is determined. If the characteristic meets the predetermined condition, a focus depth is calculated according to a three-dimensional (3D) depth information and movement of a first lens of the first sensor is driven according to the focus depth for focusing. If the characteristic does not meet the predetermined condition, the first lens is driven to move for many times to obtain a plurality of contrast values, such that movement of the first lens is driven according to the contrast values for focusing.

The disclosure provides an auto focus (AF) method, adapted to an AF apparatus, wherein the AF apparatus includes a first image sensor and a second image sensor, and the AF method includes following steps. A first image and a second image are captured by using the first image sensor and the second image sensor respectively. A focus depth is calculated according to a 3D depth information and movement of a first lens of the first sensor is driven according to the focus depth for focusing. A result image is captured by using the first sensor after the first lens moves based on the focus depth, and whether the result image meets a predetermined condition is determined. If the result image does not meet the predetermined condition, the first lens is driven to move for many times to obtain a plurality of contrast values, such that movement of the first lens is driven according to the contrast values for focusing.

The disclosure provides an auto focus (AF) apparatus which includes a first image sensor, a second image sensor, a focusing position control module and a processing unit. The first image sensor and the second image sensor photograph a target object to generate a first image and a second image. The focusing position control module controls a focusing position of the first image sensor. The processing unit is coupled to the first image sensor, the second image sensor, and the focusing position control module. The processing unit is configured for executing: detecting at least one characteristic based on the first image, and determining whether the characteristic meets a predetermined condition; if the characteristic meets the predetermined condition, calculating a focus depth according to a three-dimensional (3D) depth information and driving movement of a first lens of the first sensor according to the focus depth for focusing; and if the characteristic does not meet the predetermined condition, driving the first lens to move for many times to obtain a plurality of contrast values, so as to .driving movement of the first lens according to the contrast values for focusing.

The disclosure provides an auto focus (AF) apparatus. The AF apparatus includes a first image sensor, a second image sensor, a focusing position control module and a processing unit. A first image sensor and a second image sensor photograph a target object to generate a first image and a second image. The focusing position control module controls a focusing position of the first image sensor. The processing unit is coupled to the first image sensor, the second image sensor, and the focusing position control module. The processing unit is configured for executing: calculating a focus depth according to a 3D depth information and driving movement of a first lens of the first sensor according to the focus depth for focusing; capturing a result image by using the first sensor after the first lens moves based on the focus depth, and determining whether the result image meets a predetermined condition; an if the result image does not meet the predetermined condition, driving the first lens to move for many times to obtain a plurality of contrast values, so as to drive movement of the first lens according to the contrast values for focusing.

As described above, in an AF method and an AF apparatus provided by the disclosure, a 3D depth map is generated through a stereoscopic image processing technique, and an optimization process is performed on the 3D depth map to obtain a focusing position. Thus, an AF action can be performed within a single image shooting period. Thereby, the AF apparatus and the AF method provided by the disclosure offer a faster speed of auto focusing. Additionally, because it is not needed to search for the maximum focus value, the phenomenon of breathing is avoided, and accordingly the image stability is improved.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an auto focus (AF) apparatus according to an embodiment of the disclosure.

FIG. 2 is a flowchart of an AF method according to an embodiment of the disclosure.

FIG. 3 is a block diagram of a storage unit and a processing unit in the embodiment illustrated in FIG. 1.

FIG. 4 is a flowchart of an AF method according to another embodiment of the disclosure.

FIG. 5 is a flowchart of a step for determining a piece of optimized depth information of a target object in the embodiment illustrated in FIG. 4.

FIG. 6 is a flowchart of an AF method according to yet another embodiment of the disclosure.

FIG. 7 is a flowchart of an AF method according to an embodiment of the disclosure.

FIG. 8 is a schematic view of a contrast value curve of the present disclosure.

FIG. 9 is a flowchart of an AF method according to an embodiment of the disclosure.

FIG. 10 is a flowchart of an AF method according to an embodiment of the disclosure.

FIG. 11 is a block diagram of one embodiment of an auto focus apparatus using multiple lenses of the present disclosure.

FIG. 12 is a block diagram of one embodiment of the auto focus apparatus using multiple lenses of the present disclosure.

FIG. 13 is a flow diagram of one embodiment of the auto focus method using multiple lenses of the present disclosure.

FIG. 14 which is a flow diagram of one embodiment of the auto focus method using multiple lenses of the present disclosure.

### DESCRIPTION OF THE EMBODIMENTS

Reference will now be made in detail to the present preferred embodiments of the invention, examples of which are illustrated in the accompanying drawings.

Wherever possible, the same reference numbers are used in the drawings and the description to refer to the same or like parts.

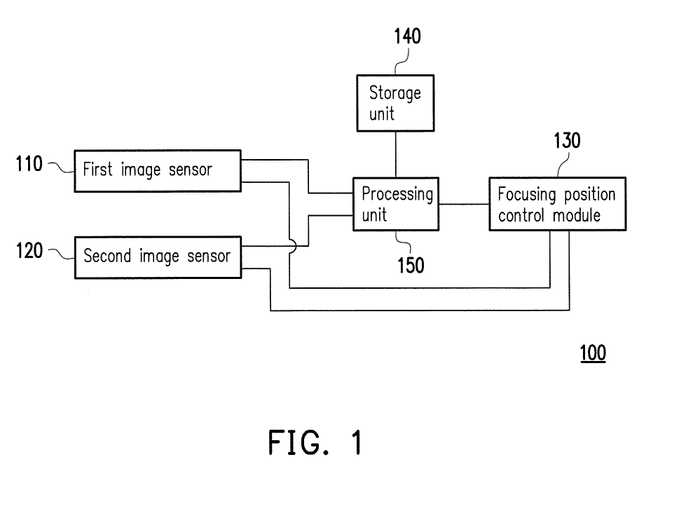

FIG. 1 is a block diagram of an auto focus (AF) apparatus according to an embodiment of the disclosure. Referring to FIG. 1, the AF apparatus 100 in the present embodiment includes a first image sensor 110, a second image sensor 120, a focusing position control module 130, a storage unit 140, and a processing unit 150. In the present embodiment, the AF apparatus 100 is a digital camera, a digital video camcorder (DVC), or any other handheld electronic apparatus which can be used for capturing videos or photos. However, the type of the AF apparatus 100 is not limited in the disclosure.

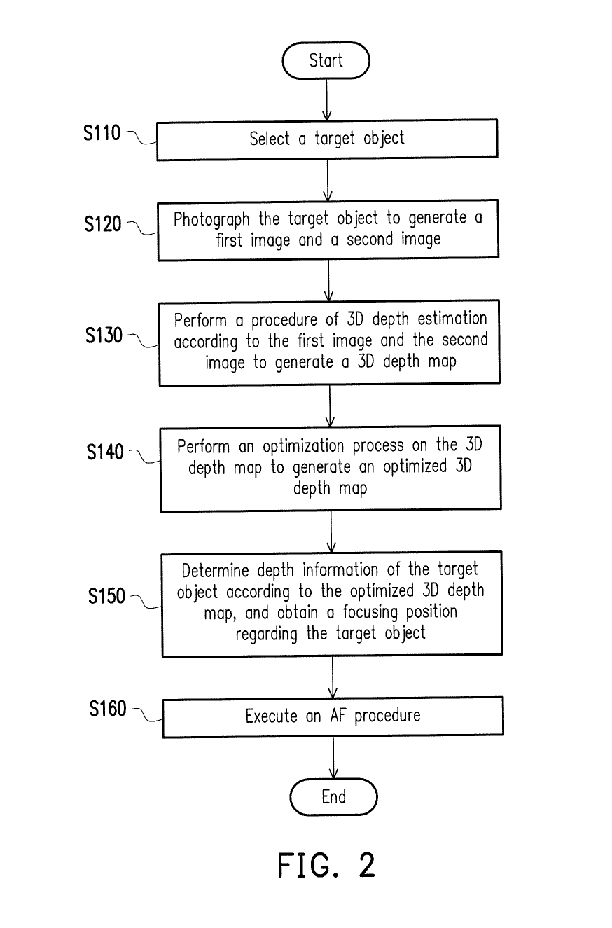

Referring to FIG. 1, in the present embodiment, the first image sensor 110 and the second image sensor 120 respectively might include elements, such as a lens, a photosensitive element, an aperture and so forth, which are used to capture images. Besides, the focusing position control module 130, the storage unit 140, and the processing unit 150 may be functional modules implemented as hardware and/or software, wherein the hardware may be any one or a combination of different hardware devices with image processing functions, such as a central processing unit (CPU), a system on chip (SOC), an application specific intergrated circuit (ASIC), a digital signal processor (DSP), a chipset, and a microprocessor, and the software may be an operating system (OS) or driver programs. In the present embodiment, the processing unit 150 is coupled to the first image sensor 110, the second image sensor 120, the focusing position control module 130, and the storage unit 140. The processing unit 150 controls the first image sensor 110, the second image sensor 120, and the focusing position control module 130 and stores related information into the storage unit 140. Below, the functions of different modules of the AF apparatus 100 in the present embodiment will be explained in detail with reference to FIG. 2.

FIG. 2 is a flowchart of an AF method according to an embodiment of the disclosure. Referring to FIG. 2, the AF method in the present embodiment can be executed by the AF apparatus 100 illustrated in FIG. 1. Below, the AF method in the present embodiment will be described in detail with reference to different modules of the AF apparatus 100.

First, in step S110, a target object is selected. To be specific, in the present embodiment, a click signal for selecting the target object may be received from a user through the AF apparatus 100 to select the target object. For example, the user can select the target object through a touch action or by moving an image capturing apparatus to a specific area. However, the disclosure is not limited thereto. In other embodiments, an object detecting procedure may be executed through the AF apparatus 100 to automatically select the target object and obtain a coordinate position of the target object. For example, the AF apparatus 100 can automatically select the target object and obtain the coordinate position thereof through face detection, smile detection, or subject detection. However, the disclosure is not limited thereto, and those having ordinary knowledge in the art should be able to design the mechanism for selecting the target object in the AF apparatus 100 according to the actual requirement.

Then, in step S120, the target object is captured by using the first image sensor 110 and the second image sensor 120 to respectively generate a first image and a second image. For example, the first image is a left-eye image, and the second image is a right-eye image. In the present embodiment, the first image and the second image are stored in the storage unit 140 to be used in subsequent steps.

Next, in step S130, the processing unit 150 performs a procedure of 3D depth estimation according to the first image and the second image to generate a 3D depth map. To be specific, the processing unit 150 performs image processing through a stereoscopic vision technique to obtain a 3D coordinate position of the target object in the space and depth info nation of each point in the images. After obtaining the piece of initial depth information of each point, the processing unit 150 integrates all pieces of depth information into a 3D depth map.

Thereafter, in step S140, the processing unit 150 performs an optimization process on the 3D depth map to generate an optimized 3D depth map. To be specific, in the present embodiment, a weighted processing is performed on the piece of depth information of each point and the pieces of depth information of adjacent points through an image processing technique. For example, in the present embodiment, the optimization process is a Gaussian smoothing process. In short, during the Gaussian smoothing process, each pixel value is a weighted average of adjacent pixel values. Since the original pixel has the maximum Gaussian distribution value, it has the maximum weight. As to the adjacent pixels, the farther a pixel is away from the original pixel, the smaller weight the pixel has. Thus, after the processing unit 150 performs the Gaussian smoothing process on the 3D depth map, the pieces of depth information of different points in the image can be more continuous, and meanwhile, the pieces of marginal depth information of the image can be maintained. Thereby, not only the problem of vague or discontinuous depth information carried by the 3D depth map can be avoided, but the holes in the 3D depth map can be fixed by using the pieces of depth information of adjacent points. However, even though the optimization process is assumed to be a Gaussian smoothing process in foregoing description, the disclosure is not limited thereto. In other embodiments, those having ordinary knowledge in the art can perform the optimization process by using any other suitable statistical calculation method according to the actual requirement, which will not be described herein.

Next, in step S150, the processing unit 150 determines the piece of depth information corresponding to the target object according to the optimized 3D depth map and obtains a focusing position regarding the target object according to the piece of depth information. To be specific, to obtain the focusing position regarding the target object according to the piece of depth information, a depth table may be inquired according to the piece of depth information to obtain the focusing position regarding the target object. For example, while executing the AF procedure, the number of steps of a stepping motor or the magnitude of current of a voice coil motor in the AF apparatus 100 is controlled through the focusing position control module 130 to respectively adjust the zoom lenses of the first image sensor 110 and the second image sensor 120 to desired focusing positions, so as to focus. Thus, the relationship between the number of steps of the stepping motor or the magnitude of current of the voice coil motor and the clear depth of the target object can be determined in advance through an beforehand calibration procedure of the stepping motor or the voice coil motor, and the corresponding data can be recorded in the depth table and stored into the storage unit 140. Thereby, the number of steps of the stepping motor or the magnitude of current of the voice coil motor corresponding to current depth information of the target object can be obtained, and the focusing position regarding the target object can be obtained accordingly.

Next, in step S160, the processing unit 150 drives the AF apparatus 100 to execute an AF procedure according to the focusing position. To be specific, because the focusing position control module 130 controls the focusing positions of the first image sensor 110 and the second image sensor 120, after obtaining the focusing position regarding the target object, the processing unit 150 drives the focusing position control module 130 of the AF apparatus 100 to adjust the zoom lenses of the first image sensor 110 and the second image sensor 120 to this focusing position, so as to complete the AF procedure.

As described above, a 3D depth map is generated through a stereoscopic image processing technique, and an optimization process is then performed on the 3D depth map to obtain a focusing position. Through such a technique, the AF apparatus 100 and the AF method in the present embodiment can complete an AF procedure within a single image shooting period. Thus, the AF apparatus 100 and the AF method in the present embodiment offer a faster speed of auto-focusing. Additionally, the phenomenon of breathing is avoided in the AF apparatus 100 and the AF method in the present embodiment, and accordingly image stability is improved.

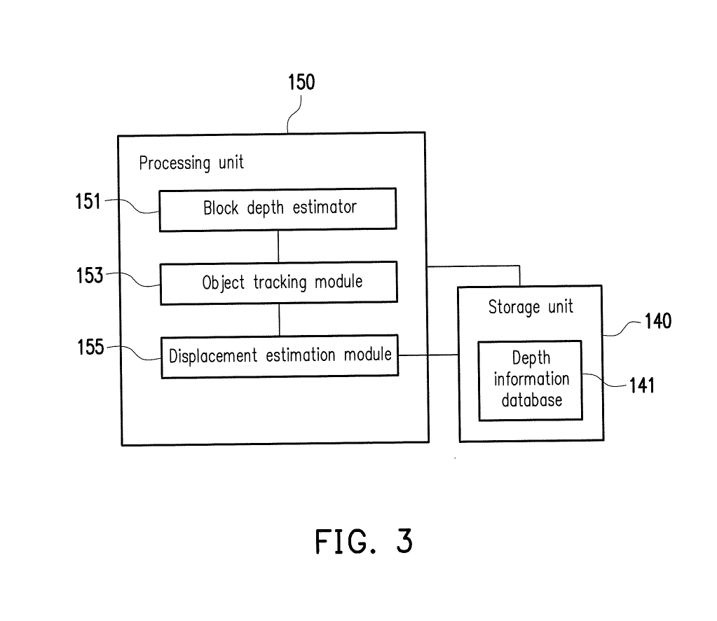

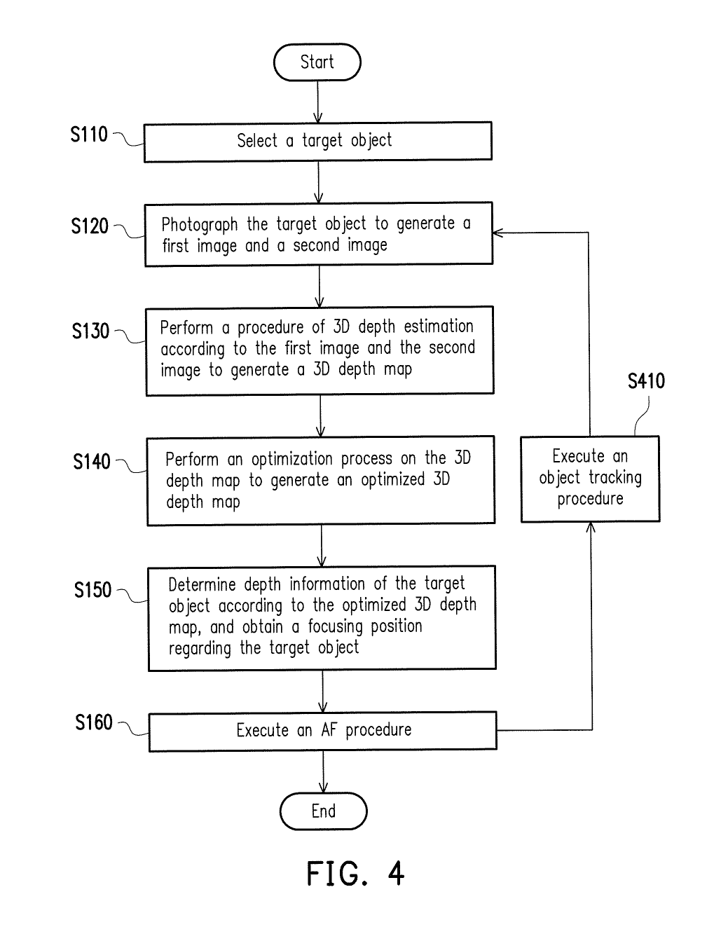

FIG. 3 is a block diagram of a storage unit and a processing unit in the embodiment illustrated in FIG. 1. Referring to FIG. 3, to be specific, in the present embodiment, the storage unit 140 of the AF apparatus 100 further includes a depth information database 141, and the processing unit 150 further includes a block depth estimator 151, an object tracking module 153, and a displacement estimation module 155. In the present embodiment, the block depth estimator 151, the object tracking module 153, and the displacement estimation module 155 may be functional blocks implemented as hardware and/or software, where the hardware may be any one or a combination of different hardware devices with image processing functions, such as a CPU, a system on chip (SOC), an application specific integrated circuit (ASIC), a digital signal processor (DSP), a chipset, and a microprocessor, and the software may be an OS or driver programs. Below, the functions of the block depth estimator 151, the object tracking module 153, the displacement estimation module 155, and the depth information database 141 in the present embodiment will be described in detail with reference to FIG. 4 to FIG. 6.

FIG. 4 is a flowchart of an AF method according to another embodiment of the disclosure. Referring to FIG. 4, the AF method in the present embodiment may be executed by the AF apparatus 100 illustrated in FIG. 1 and the processing unit 150 illustrated in FIG. 3. The AF method in the present embodiment is similar to the AF method in the embodiment illustrated in FIG. 2, and only the differences between the two AF methods will be explained below.

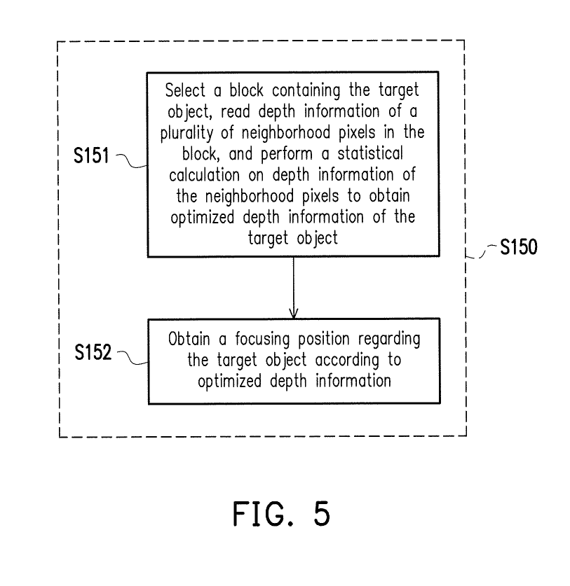

FIG. 5 is a flowchart of a step for determining a piece of optimized depth information of a target object in the embodiment illustrated in FIG. 4. Step S150 of FIG. 4 (the piece of depth information corresponding to the target object is determined according to the optimized 3D depth map, and a focusing position regarding the target object is obtained according to the piece of depth information) further includes steps S151 and S152. Referring to FIG. 5, in step S151, through the block depth estimator 151, a block containing the target object is selected, the pieces of depth information of a plurality of neighborhood pixels in the block is read, and a statistical calculation is performed on the pieces of depth information of the neighborhood pixels to obtain a piece of optimized depth information of the target object. To be specific, the statistical calculation is performed to calculate the piece of valid depth information of the target object and avoid focusing on an incorrect object.

For example, the statistical calculation may be a mean calculation, a mod calculation, a median calculation, a minimum value calculation, a quartile calculation, or any other suitable statistical calculation. To be specific, the mean calculation is to use average depth information of the block as the piece of optimized depth information for executing subsequent AF steps. The mod calculation is to use the pieces of depth information of the greatest number in the block as the piece of optimized depth information. The median calculation is to use the median value of the pieces of depth information in the block as the piece of optimized depth information. The minimum value calculation is to use the shortest object distance in the block as the piece of optimized depth information. The quartile calculation is to use a first quartile or a second quartile of the pieces of depth information in the block as the piece of optimized depth information. However, the disclosure is not limited thereto, and those having ordinary knowledge in the art can obtain the piece of optimized depth information of the target object by using any other suitable statistical calculation method according to the actual requirement, which will not be described herein.

Next, in step S152, a focusing position regarding the target object is obtained according to the piece of optimized depth information. In the present embodiment, the technique used in step S152 has been explained in detail in step S150 in the embodiment illustrated in FIG. 2 therefore will not be described herein.

Referring to FIG. 4 again, the AF method in the present embodiment further includes step S410, in which an object tracking procedure is executed on the target object through the object tracking module 153 to obtain at least one piece of characteristic information and a trajectory of the target object. To be specific, the piece of characteristic information of the target object includes gravity center information, color information, area information, contour info nation, or shape information. The object tracking module 153 extracts various elements for forming the target object from the first image and the second image by using different object tracking algorithm and then integrates these elements into the piece of characteristic information of a higher level. The object tracking module 153 tracks the target object by comparing the piece of characteristic information between continuous first images or second images generated at different time points. It should be noted that the object tracking algorithm is not limited in the disclosure, and those having ordinary knowledge in the art can obtain the piece of characteristic information and the trajectory of the target object by using any suitable object tracking algorithm according to the actual requirement, which will not be described herein. In addition, the object tracking module 153 is further coupled to the block depth estimator 151 to send the piece of characteristic information and the trajectory back to the block depth estimator 151. The block depth estimator 151 further performs statistical calculations using different weighting techniques according to the piece of characteristic information of the target object, the reliability (similarity) of a tracked and estimated pixel, and the pieces of depth information of the neighborhood pixels to make the piece of optimized depth information of the target object more accurate.

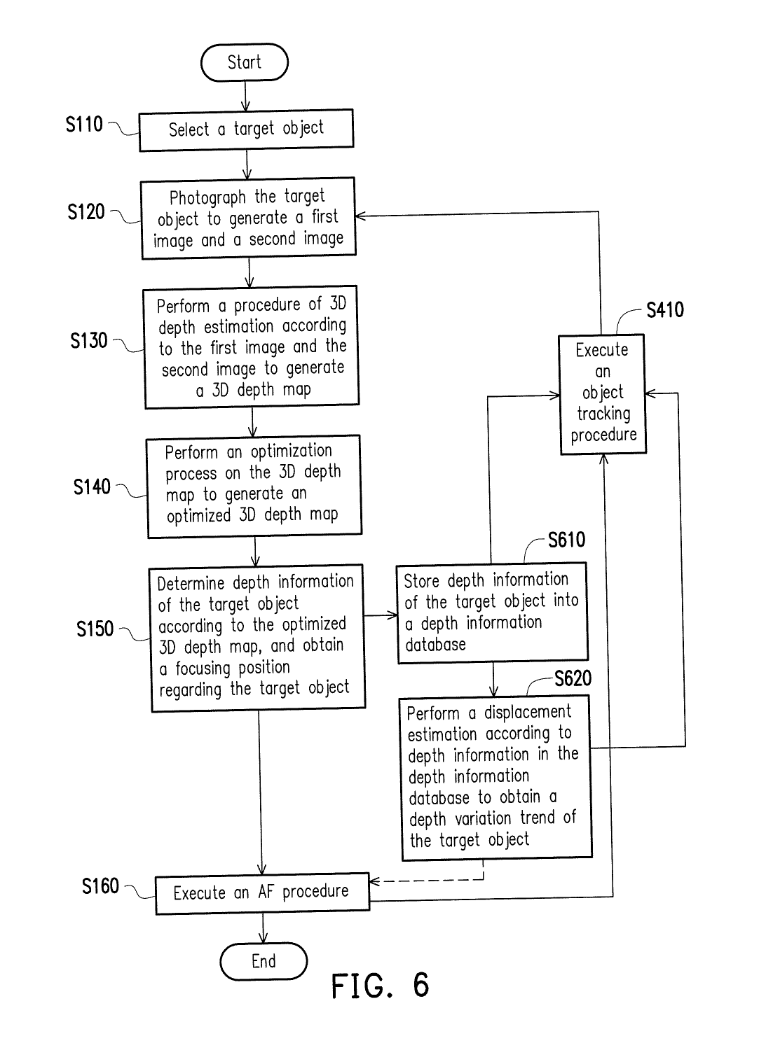

FIG. 6 is a flowchart of an AF method according to yet another embodiment of the disclosure. Referring to FIG. 6, the AF method in the present embodiment can be executed by the AF apparatus 100 illustrated in FIG. 1 and the processing unit 150 illustrated in FIG. 3. The AF method in the present embodiment is similar to the AF method in the embodiment illustrated in FIG. 4. Below, only the differences between the two AF methods will be explained.

In the present embodiment, the AF method further includes steps S610 and S620. In step S610, the pieces of depth information of the target object at different time points is stored in the depth information database 141 through the storage unit 140 and the processing unit 150 (as shown in FIG. 3). To be specific, when the AF apparatus executes step S150, it constantly obtains pieces of 3D position information of the moving target object. Thus, the processing unit 150 can input and store the pieces of depth information of the target object at different time points into the depth information database 141 in the storage unit 140.

Next, in step S620, a procedure of displacement estimation is performed by the displacement estimation module 155 according to the pieces of depth information in the depth information database 141 to obtain a depth variation trend regarding the target object. To be specific, the displacement estimation module 155 is coupled to the storage unit 140 and the focusing position control module 130. When the displacement estimation module 155 performs the displacement estimation on the pieces of depth information in the depth information database 141, the displacement estimation module 155 obtains the 3D position information variation trend (particularly, the position variation trend of the target object along the axis Z of the target object, i.e., the depth variation trend of the target object) moving in the space, so that the position of the target object at the next instant can be estimated and the AF procedure can be carried out smoothly. To be specific, after obtaining the depth variation trend of the target object, the depth variation trend of the target object is transmitted to the focusing position control module 130, so that the focusing position control module 130 controls the first image sensor 110 and the second image sensor 120 to move smoothly according to the depth variation trend. To be more specific, before the focusing position control module 130 executes the AF procedure, the AF apparatus 100 adjusts the positions of the lenses of the first image sensor 110 and the second image sensor 120 according to the depth variation trend of the target object to make the lenses of the first image sensor 110 and the second image sensor 120 to be close to the focusing position obtained in step S150. Thereby the movement of the AF apparatus 100 when it executes the AF procedure in step S160 can be very smooth, and accordingly the stability of the AF apparatus 100 is improved.

Additionally, the depth information database 141 and the displacement estimation module 155 respectively send the pieces of depth information of the target object at different time points and the depth variation trend thereof back to the object tracking module 153. According to the depth variation trend and depth information of the target object, the object tracking module 153 performs calculations and analysis on the pieces of characteristic information and depth information further. Thereby, the burden of the system is reduced and the operation speed thereof is increased. Besides, result of the object tracking procedure is made very accurate, and the focusing performance of the AF apparatus 100 is improved.

As described above, in an AF method and an AF apparatus provided by embodiments of the disclosure, a 3D depth map is generated through a stereoscopic image processing technique, and an optimization process is performed on the 3D depth map to obtain a focusing position. Thus, an AF procedure can be executed within a single image time. Thereby, the AF apparatus and the AF method provided by the disclosure offer a fast focusing speed. Additionally, because it is not needed to search for the maximum focus value repeatedly, the phenomenon of breathing is avoided, and accordingly the image stability is improved.

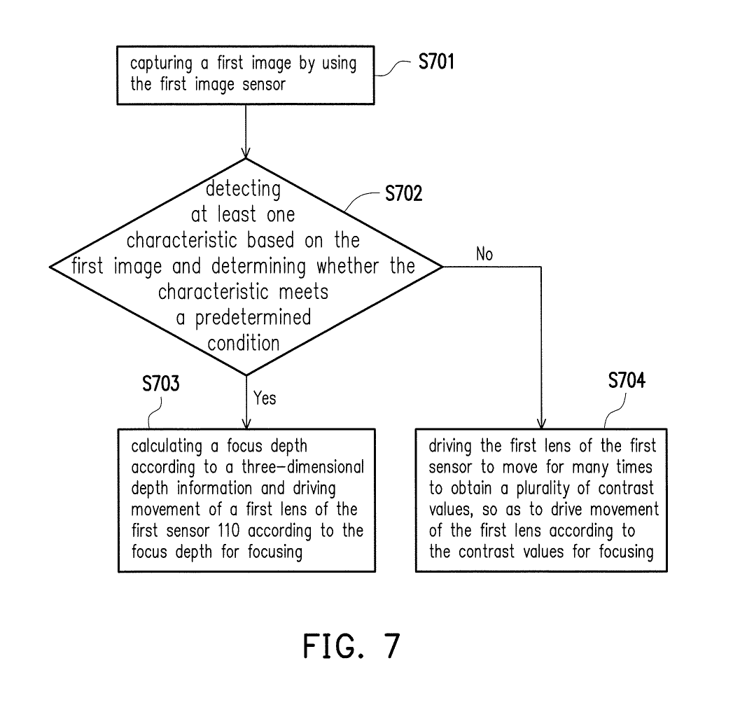

FIG. 7 is a flowchart of an AF method according to an embodiment of the disclosure. Referring to FIG. 7, the AF method in the present embodiment can be executed by the AF apparatus 100 illustrated in FIG. 1. Below, the AF method in the present embodiment will be described in detail with reference to different modules of the AF apparatus 100.

First, in step S701, a first image is captured by using the first image sensor 110. In step S702, the processing unit 150 detects at least one characteristic based on the first image and determines whether the characteristic meets a predetermined condition. Foe example, scene detection based on the first image is performed to predict whether the depth information generated under the current scene shot by the first image sensor 110 is reliable or not. Specifically, the depth information generated based on the images captured in some specific scene, such as night view, is not reliable, and the focusing position may not be obtained according to the depth information accurately. Namely, whether the result of the 3D estimation is ideal may be predicted based on the scene detection. Hence, if the processing unit 150 determines that the scene characteristic meets the predetermined condition, in step S703, the first focus module of the processing unit 150 calculates a focus depth according to a three-dimensional depth information and drives movement of a first lens of the first sensor 110 according to the focus depth for focusing.

Otherwise, if the characteristic does not meet the predetermined condition, in step S704, the second focus module of the processing unit 150 drives the first lens of the first sensor 110 to move for many times to obtain a plurality of contrast values, so as to drive movement of the first lens according to the contrast values for focusing. Simply to say, based on the scene detection, the auto focus apparatus 10 may adaptively perform focusing procedure according to the focusing position, which is obtained based on the focus depth or obtained based on the contrast values.

However, if the brightness of the images used for depth calculation is not suitable, such as over bright or not bright enough, the depth calculation is easy to fail. Therefore, brightness of the scene may be detected in advance, such that the processing unit 150 may select to use the focusing position obtained from the focus depth or the contrast values to performing focusing accordingly. In one of the embodiments of the disclosure, the processing unit 150 determines whether the scene characteristic meets the predetermined condition, in step S702, by determining whether the brightness reference value is within a predetermined range. In detail, the processing unit 150 calculates a brightness reference value of the first image and then determines whether the brightness reference value is within a predetermined range. The characteristic meets the predetermined condition if the brightness reference value is within the predetermined range, and the scene characteristic does not meet the predetermined condition if the brightness reference value is not within the predetermined range. The predetermined range may be designed or implement according to the practical used, the disclosure is not limited thereto. Simply to say, in one of the embodiments of the disclosure, once the brightness is not within the predetermined range is detected, the second focus module of the processing unit 150 chose to drive the first lens of the first sensor 110 to move for many times to obtain the contrast values, so as to perform auto focusing procedure based on the contrast values.

Besides, the processing unit 150 may determine whether the characteristic meets the predetermined condition by determining whether repeated pattern appears in the first image. The repeated pattern may cause the depth calculation has less precision, such that the focusing position obtained based on the calculated depth has a risk of failure. Therefore, the repeated pattern of the scene may be detected in advance, such that the processing unit 150 may select to use the focusing position obtained from the focus depth or the contrast values to performing focusing accordingly. In one of the embodiments of the disclosure, the processing unit 150 determines whether the characteristic meets the predetermined condition, in step S702, by detecting whether a repeated pattern appears in the first image. If the repeated pattern does not appear in the first image is determined by the processing unit 150, the characteristic meets the predetermined condition. On the other hand, if the repeated pattern appears in the first image is determined by the processing unit 150, the characteristic does not meet the predetermined condition.

Furthermore, the processing unit 150 may determine whether the characteristic meets the predetermined condition by determining whether the first image lacks texture characteristic according to the texture information. Since the lack of texture may easily reduce the precision of the 3D depth estimation, and the focusing position obtained based on the calculated depth has a risk of failure accordingly. Therefore, the texture detection may be performed in advance, such that the processing unit 150 may select to use the focusing position obtained from the focus depth or the contrast values to performing focusing based on the texture information of the first image. In one of the embodiments of the disclosure, the processing unit 150 performs a texture detection procedure on the first image to obtain texture information, and then determines whether the first image lacks texture characteristic according to the texture information. If the first image does not lack texture characteristic, the processing unit 150 determines that the characteristic meets the predetermined condition. On the other hand, if the first image lacks texture characteristic, the processing unit 150 determines that the characteristic does not meet the predetermined condition.

In one of the embodiments of the disclosure, whether both of the images are in a suitable status for calculating the depth information may be judged by the processing unit 150. For example, if the user's finger may cover one of the lenses while photographing, the 3D depth estimation based on the images may not be performed normally and correctly. Namely, the two images used for performing 3D depth estimation are correlative with each other, since the two image sensors capture the images respectively at the same time and toward the same scene. Once the images are low-correlated with each other, the 3D depth estimation may easily fail.

In one of the embodiments, whether the first image and the second image are low-correlated with each other may be determined by performing a feature detection on the first image and the second image, but it is not limited thereto. Any statistics of the pixels of the first image and the second image, such as the average of the brightness, the average of color component of the pixels, the edge information, the texture information and so on, may be compared to determine whether the first image and the second image are low-correlated with each other. If the difference between the statistics of the first image and the second image is apparent or greater than a threshold, the first image and the second image are low-correlated with each other is determined by the processing unit. Hence, the processing unit 150 determines whether the first image and the second image are low-correlated with each other based on image capturing information of the first image and the second image or performing feature detection on the first image and the second image. If the first image and the second image are low-correlated with each other, the processing unit 150 drives the first lens to move for many times to obtain the contrast values, so as to drive the movement of the first lens according to the contrast values for focusing. On the other hand, if the first image and the second image are not low-correlated with each other, the processing unit 150 drives the first lens to move for many times to obtain the contrast values, so as to drive the movement of the first lens according to the contrast values for focusing.

Based on above, when the images satisfy the requirement of scene characteristic of the photographed scene and correlation between the images, the first focus module of the processing unit 150 calculates the focus depth according to the 3D depth info illation and driving movement of a first lens of the first sensor according to the focus depth for focusing. The technology related to the depth based focusing approach is described above, so the detail description is omitted. Simply to say, the first focus module of the processing unit 150 first performs a 3D depth estimation according to the first image and the second image to generate a 3D depth map, determines the 3D depth information corresponding to a target object according to the 3D depth map, and obtains the focus depth regarding the target object according to the 3D depth information. To be specific, to obtain the focusing position regarding the target object according to the piece of depth information, a depth table may be inquired according to the piece of depth information to obtain the focusing position regarding the target object.

On the other hand, when the images satisfy the requirement of scene characteristic of the photographed scene and correlation between the images, the processing unit 150 controls the focusing position control module 130 to drive the first lens to move for many times and obtain a plurality of contrast values accordingly. The second focus module of processing unit 150 generates a contrast value curve according to the contrast values, and the position corresponding to the maximum value of the contrast value curve is used as a focus position. The second focus module of the processing unit 150 controls the focusing position control module 130 to drive the first lens moving to the focus position obtained from the contrast values for focusing.

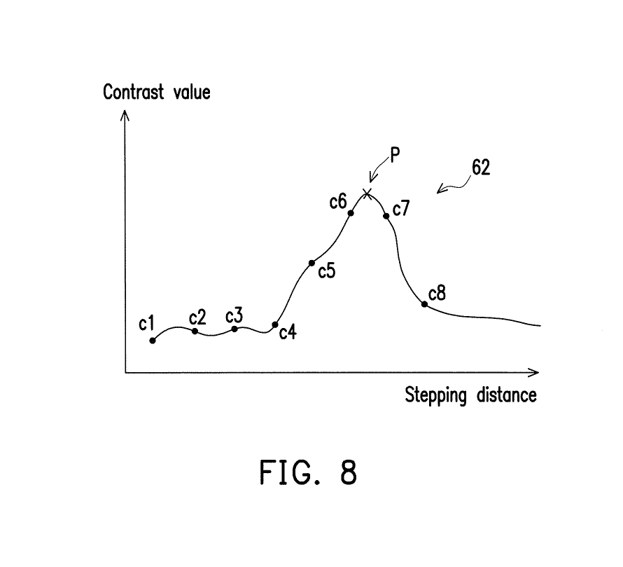

In details, the second focus module of controls the focusing position control module 130 to drive the first lens of the first image sensor 110 to move for many times and calculates the contrast values of the captured images after each of movements. For example, the first lens of the first image sensor 110 are driven to move for eight times, as shown in FIG. 8, and the eight contrast values c1-c8 are calculated. Each contrast value c1-c8 indicates the sharpness and clear degree of the image content, so the position corresponding to the maximum contrast value is usually selected as the focus position.

In implementation, the position corresponding to the maximum value within the contrast values c1-c8 can be the focus position directly, and it is the position corresponding to the contrast value c6 in this case; alternatively, the second focus module of the processing unit 150 can generate a contrast value curve 62 according to the contrast values c1-c8, the contrast value curve 62 being a multiple degree polynomial in one variable, as shown in FIG. 8. Next, the position corresponding to the peak value of the contrast value curve 62 is used as the focus position, which is the position P in FIG. 8. Therefore, the focusing position control module 130 can be controlled by the second focus module to drive the first lens to move to the focus position for focusing according to the calculated contrast values.

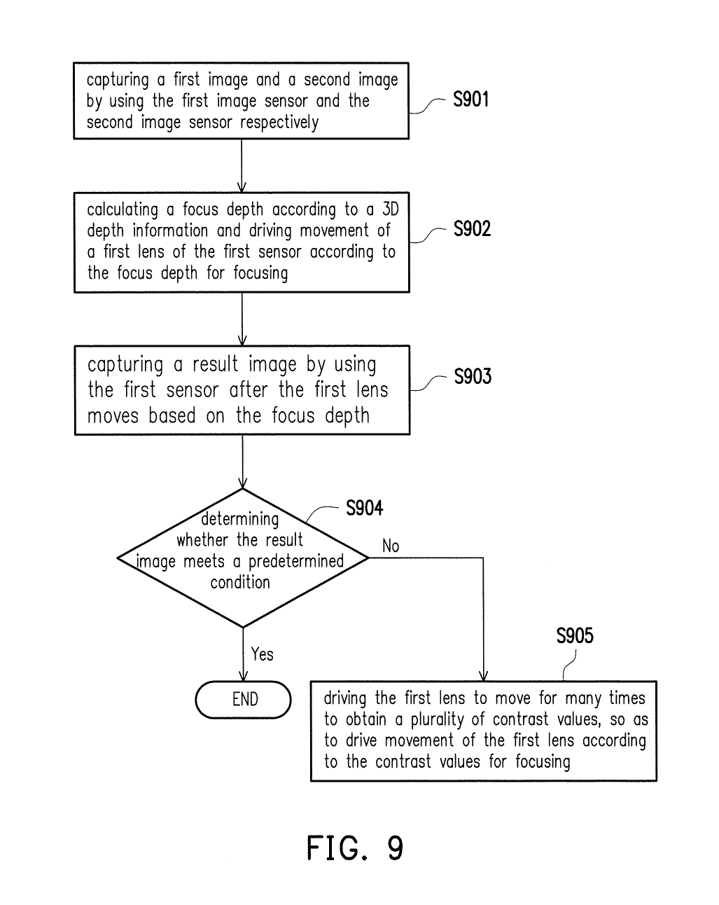

FIG. 9 is a flowchart of an AF method according to an embodiment of the disclosure. Referring to FIG. 9, the AF method in the present embodiment can be executed by the AF apparatus 100 illustrated in FIG. 1. Below, the AF method in the present embodiment will be described in detail with reference to different modules of the AF apparatus 100.

First, in step S901, the processing unit 150 captures a first image and a second image by using the first image sensor 110 and the second image sensor 120 respectively. In the embodiment illustrated in FIG. 9, the first focus module of the processing unit 150 executes a 3D depth estimation directly after the first image and the second image are captured. Therefore, in step S902, the first focus module of the processing unit 150 calculates a focus depth according to a 3D depth information and drives movement of a first lens of the first sensor 110 according to the focus depth for focusing. The technology related to the depth based focusing approach is described above, so the detail description is omitted. In order to check accuracy of the focusing position generated by 3D depth estimation, a result image captured based on the focusing position generated by 3D depth estimation may be examined by the processing unit 150.

Hence, in step S903, the processing unit 150 captures a result image by using the first sensor after the first lens moves based on the focus depth. In step S904, the processing unit 150 determines whether the result image meets a predetermined condition. If the result image does not meet the predetermined condition, in step S905, second focus module of the processing unit 150 drives the first lens to move for many times to obtain a plurality of contrast values, so as to drive movement of the first lens according to the contrast values for focusing. Namely, if the result image does not meet the predetermined condition, it can be determined that the result image is photographed based on a undesirable focusing position, and the second focus module of the processing unit 150 may generate a new focusing position again by driving the first lens to move many times and calculating the contrast values.

Specifically, sharpness of the result image may be used as a judgment criterion for determining whether the result image meets a predetermined condition. In one of the embodiments of the disclosure, the processing unit 150 estimates a result sharpness level in a focusing frame of the result image and estimates a absolute sharpness level outside the focusing frame of the result image. The processing unit 150 compares the result sharpness level in the focusing frame and the absolute sharpness level outside the focusing frame. If the absolute sharpness level is greater than the result sharpness level, the result image does not meet the predetermined condition. Specifically to say, once the result image is captured based on the undesirable focusing position, the sharpness of the result image in the focusing frame may be worse than the sharpness of the result image outside the focusing frame.

However, the sharpness of the result image in the focusing frame may be also compared with the first image which is captured based on a default focusing position. In one of the embodiments of the disclosure, the processing unit 150 estimates a result sharpness level in a focusing frame of the result image and estimates a relative sharpness level in the focusing frame of the first image. Afterward, the processing unit 150 compares the result sharpness level of the result image and the relative sharpness level of the first image. If the relative sharpness level is greater than the result sharpness level, the result image does not meet the predetermined condition is determined by the processing unit 150. Specifically to say, since the first image is captured based on the undesirable focusing position, the sharpness of the first image in the focusing frame may be worse than the sharpness of the result image in the focusing frame. Hence, once the relative sharpness level in the focusing frame of the first image is detected being better than the result sharpness level of the result image, the processing unit 150 is aware of the focusing position obtained based on the focus depth is not ideal, and may generate a new focusing position again by driving the first lens to move many times and calculating the contrast values.

Besides, the fact of the focusing position obtained based on the focus depth is not ideal may be predicted by the first focus module of the processing unit 150 while performing the 3D depth estimation. Specifically, the accuracy of the 3D depth map may affect the performance of focusing procedure based on the 3D depth estimation. In other words, the focus depth may not be generated correctly and accurately due to the poor performance of the 3D depth map. Therefore, the performance of the 3D depth map may be a decision criterion to select the focusing position obtained based on the focus depth or the focusing position obtained based on the contrast values for focusing. For example, the 3D depth map records a plurality of depth values and has a plurality of holes, the amount or the distribution of the holes in the 3D depth map may serve as reliability of the 3D depth map, and whether the reliability of the 3D depth map is good enough is determined, so as to avoid the implement of the undesirable focusing position which is obtained based on the depth information. It should be noted that, in one of the embodiments of the disclosure, the first focus module of the processing unit 150 may perform an optimization process on the 3D depth map to generate an optimized 3D depth map for replacing the 3D depth map.

In one of the embodiments of the disclosure, the first focus module of the processing unit 150 checks a reliability level of the 3D depth map according to a plurality of depth values recorded in the 3D depth map. Furthermore, whether the depth values in the focusing frame are reliable is determined, such that whether the focus depth is ideal could be predicted accordingly. For example, whether the depth values are reliable may be detected by comparing the depth value with the adjacent depth value in the 3D depth map. If the reliability level of the 3D depth map is not greater than a reliability threshold, the second focus module of the processing unit 150 drives the first lens to move for many times to obtain the contrast values, so as to drive the movement of the first lens according to the contrast values for focusing.

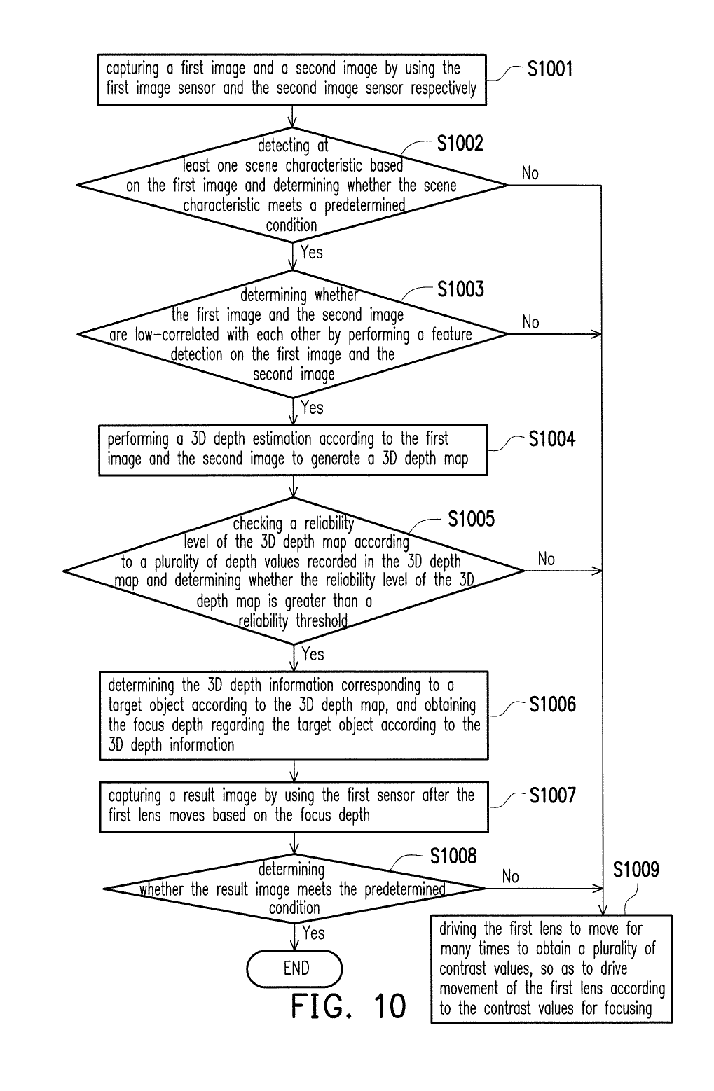

FIG. 10 is a flowchart of an AF method according to an embodiment of the disclosure. Referring to FIG. 10, the AF method in the present embodiment can be executed by the AF apparatus 100 illustrated in FIG. 1. Below, the AF method in the present embodiment will be described in detail with reference to different modules of the AF apparatus 100.

First, in step S1001, the processing unit 150 captures a first image and a second image by using the first image sensor 110 and the second image sensor 120 respectively. In step S1002, the processing unit 150 detects at least one scene characteristic based on the first image and determines whether the scene characteristic meets a predetermined condition. If the scene characteristic does not meet the predetermined condition, in step S1009, the processing unit 150 drives the first lens of the first sensor 110 to move for many times to obtain a plurality of contrast values, so as to drive movement of the first lens according to the contrast values for focusing.

If the scene characteristic meets the predetermined condition, in step S1003, the processing unit 150 determines whether the first image and the second image are low-correlated with each other by performing a feature detection on the first image and the second image. The detail of determining whether the first image and the second image are low-correlated with each other has been descried above and may not been repeated again. If step S1003 is determined to be ‘no’, in step S1009, the processing unit 150 drives the first lens of the first sensor 110 to move for many times to obtain a plurality of contrast values, so as to drive movement of the first lens according to the contrast values for focusing.

If step S1003 is determined to be ‘yes’, in step S1004, the processing unit 150 performs a 3D depth estimation according to the first image and the second image to generate a 3D depth map. Afterward, in step S1005, the processing unit 150 checks a reliability level of the 3D depth map according to a plurality of depth values recorded in the 3D depth map and determines whether the reliability level of the 3D depth map is not greater than a reliability threshold. If the reliability level of the 3D depth map is not greater than a reliability threshold, in the step S1009, the processing unit 150 drives the first lens to move for many times to obtain the contrast values, so as to drive the movement of the first lens according to the contrast values for focusing.

If the reliability level of the 3D depth map is greater than a reliability threshold, in step S1006, the processing unit 150 determines the 3D depth information corresponding to a target object according to the 3D depth map, and obtains the focus depth regarding the target object according to the 3D depth information. In step S1007, the processing unit 150 captures a result image by using the first sensor 110 after the first lens moves based on the focus depth. Afterward, in step S1008, the processing unit 150 determines whether the result image meets the predetermined condition. If the result image does not meet the predetermined condition, in the step S1009, the processing unit 150 drives the first lens to move for many times to obtain the contrast values, so as to drive the movement of the first lens according to the contrast values for focusing.

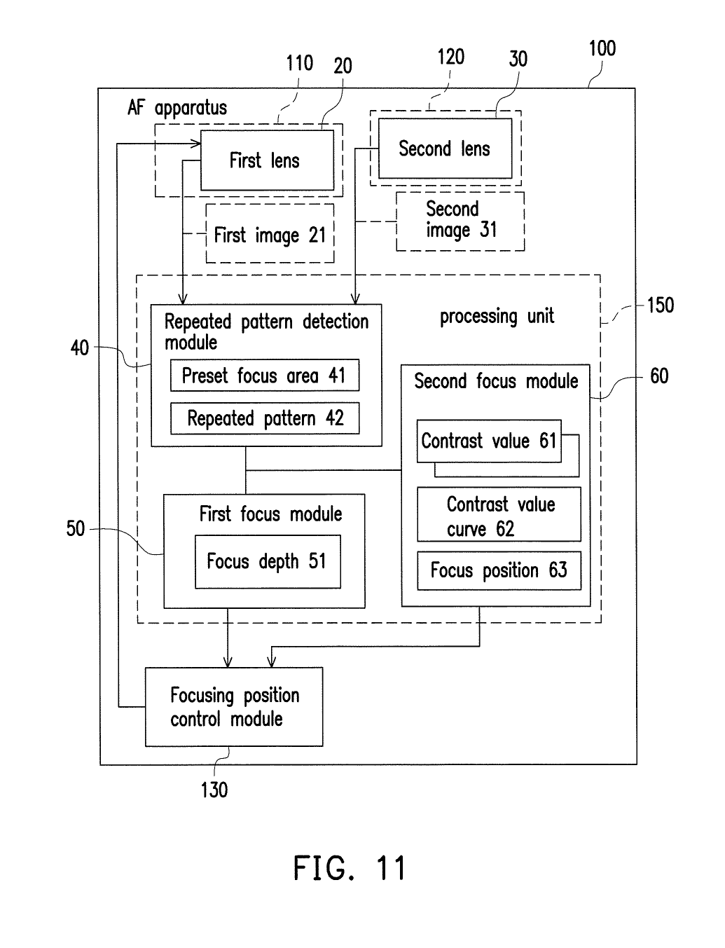

FIG. 11 is a block diagram of one embodiment of an auto focus apparatus using multiple lenses of the present disclosure. Please refer to FIG. 11, the auto focus apparatus 100 includes the first image sensor 110, the second image sensor 120, a focusing position control module 130 and the processing 150. In the embodiment, the first image sensor 110 includes a first lens 20 and the second image sensor 120 includes a second lens 30.

The focusing position control module 130 comprises a stepper motor and a driving mechanism connected with the stepper motor and an optic lens group inside the first lens 20 and/or the second lens 30, so that the optic lens group can be driven to move by controlling the rotation direction and stepping amount of the stepper motor, to change the imaging effect of the optic lens group on the image sensor unit. For convenient illustration, in the below paragraph the driving way is abbreviated that the focusing position control module 130 drives movements of the first lens 20 for focusing, to replace the above detail description of the driving way.

The processing unit 150 comprises a repeated pattern detection module 40, a first focus module 50, and a second focus module 60. The first focus module 50 uses a focus depth based approach to perform the focusing, and the second focus module 60 use a contrast value based approach to perform the focusing. Because the two focusing approaches have advantages and drawbacks respectively, the auto focus apparatus 100 combines the advantages of the two focusing approaches and avoids their drawbacks, to obtain the optimal focusing effect.

The repeated pattern detection module 40 receives a first image 21 and a second image 31 from the first image sensor 110 and the second image sensor 120, respectively, and detects whether a repeated pattern 42 appears in a preset focus area 41 of the first image 21 and the second image 31. In implementation, the preset focus area 41 is located at the central area of the first image 21 and the second image 31.

Because the first lens 20 and the second lens 30 are disposed in the different positions on the auto focus apparatus 100, the first image 21 and the second image 31 having different view angles can be obtained simultaneously for calculating a depth of a specific object in the two images. The operation of the focusing is to move at least one optical lens element inside the lens to converge the optical signal of the specific object on the image sensor unit, so the image of the specific object can be clear. Therefore, if the focus depth for the specific object can be obtained, the position of the at least one optical lens element corresponding to the focus depth can be evaluated, so that the focusing can be completed by just moving the at least one optical lens element one time and the focus time can be shorten efficiently.

However, if the specific object has a repeated pattern, the depth calculation is easy to fail. Therefore, before the focusing is performed, the repeated pattern detection module 40 judges whether the repeated pattern 42 appears in a preset focus area 41 of the first image 21 and/or the second image 31 in advance.

When the repeated pattern detection module 40 judges that the repeated pattern 42 does not appears, it indicates that the depth calculation has more precision in this situation and the focus depth based focusing approach can be used. The first focus module 50 calculates the focus depth 51 according to the first image 21 and the second image 31 and respectively controls the focusing position control module 130 to drive movement of the first lens 20 and the second lens 30 for the focusing. The technology related to the depth based focusing approach is well known by the skiller in this technology field, so the detail description is omitted.

On the other hand, when the repeated pattern detection module 40 judges that the repeated pattern 42 appears, it indicates that the depth calculation has less precision in this situation and the focusing based on the calculated depth has a risk of failure, so the contrast value based focusing approach is used by the second focus module 60.

The second focus module 60 drives the first lens 20 to move for many times and calculates contrast values 61 of the captured first image 21 after each of movements. Therefore, the focusing position control module 130 can be controlled to drive the first lens 20 to move to the focus position 63 for focusing according to the calculated contrast values 61. In conclusion, the focusing approach of the second focus module 60 is not impaired by the repeated pattern, so the auto focus apparatus 100 of the present disclosure can combine the advantages of the two focusing approaches. When the repeated pattern does not appear, the auto focus apparatus 100 utilizes the depth for quickly focusing. When the repeated pattern appears, the auto focus apparatus 100 utilizes the contrast value based focusing approach to perform focusing.

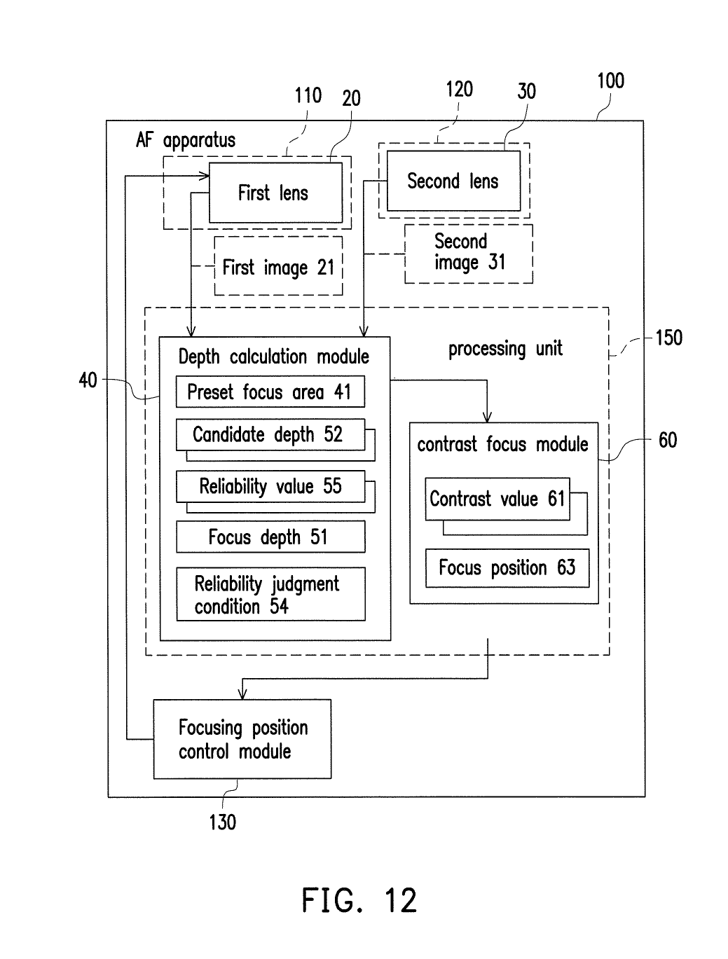

FIG. 12 is a block diagram of one embodiment of the auto focus apparatus using multiple lenses of the present disclosure. Please refer to FIG. 12, the auto focus apparatus 100 includes a first image sensor 110 having a first lens 20, a second image sensor 120 having a second lens 30, a focusing position control module 130 and a processing unit 150. The processing unit 150 comprises a depth calculation module 40 and a contrast focus module 60.

The depth calculation module 40 receives a first image and a second image 21 from the first image sensor 110 and the second image sensor 120, respectively, and calculates a focus depth 51 or a plurality of candidate depths 52 according to a preset focus area 41 in the first image 21 and the second image 31. In implementation, the preset focus area 41 is located at the central area of the first image 21 and the second image 31.

In implementation, because the image is consisted of multiple pixels, and the depth calculation module 40 uses one pixel or a group of multiple pixels as a unit of calculation, so the depth calculation module 40 generates a plurality of candidate depths 52 for the preset focus area 41 of the first image 21 and the second image 31, and each candidate depth 52 has a reliability value 55.

Higher reliability value 55 indicates the candidate depth 52 is more precise. However, if the maximum value of the all reliability values 55 is not higher than a preset threshold, or multiple higher reliability values 55 of the all reliability values 55 are very close, it is not easy to judge a correct depth for an object in preset focus area 41. Therefore, the depth calculation module 40 determines the focus depth 51 from the candidate depths 52 according to a reliability judgment condition 54. For example, the reliability judgment condition 54 comprises that the candidate depth 52, which is used as the focus depth 51, of which the reliability value 55 must be higher than the preset threshold, and the highest reliability value 55 must be higher than the second higher reliability value 55 by a certain ratio.

However, if the repeated pattern appears in the preset focus area 41 of the first image 21 and the second image 31, it is possible that all reliability values 55 are lower than the preset threshold, or there are multiple highest reliability values 55 and it is not easy to judge which one being correct. Therefore, when the depth calculation module 40 cannot determine the focus depth 51 according to the reliability judgment condition 54, the depth calculation module 40 outputs the candidate depths 52.

The contrast focus module 60 is connected electrically with the depth calculation module 40. When the depth calculation module 40 outputs the focus depth 51, the contrast focus module 60 activates the focusing position control module 130 to respectively control the first lens 20 to move to a position corresponding to the focus depth 51.

When the depth calculation module 40 outputs candidate depths 52, it indicates that other information is required for judging the focus position, so the contrast focus module 60 controls the focusing position control module 130 to respectively drive the first lens 20 to move to positions corresponding to the candidate depths 52, and respectively obtains a plurality of contrast values 61.

The focus position can be determined from the candidate depths 52 due to the repeated pattern, but the calculation of contrast value is not impaired by the repeated pattern, so the contrast focus module 60 then calculates the contrast values 61 corresponding to the candidate depths 52, respectively, and uses the candidate depth 52 having the maximal contrast value 61 as the focus position 63. Next, the contrast focus module 60 controls the first lens 20 to move to the position corresponding to the focus depth 51 for the focusing.

In conclusion, when the depth calculation module 40 of the auto focus apparatus 100 of the present disclosure cannot determine the focus depth 51, it indicates that the repeated pattern appears in the image possibly, and the focusing may fail if the focusing is performed according to the depth. Therefore, the auto focus apparatus 100 of the present disclosure combines the calculation of the contrast value which is not impaired by the repeated pattern to find the better candidate depth 52 from the candidate depths 52 according to the contrast values, so that both of the speed and precision of focusing can be improved.

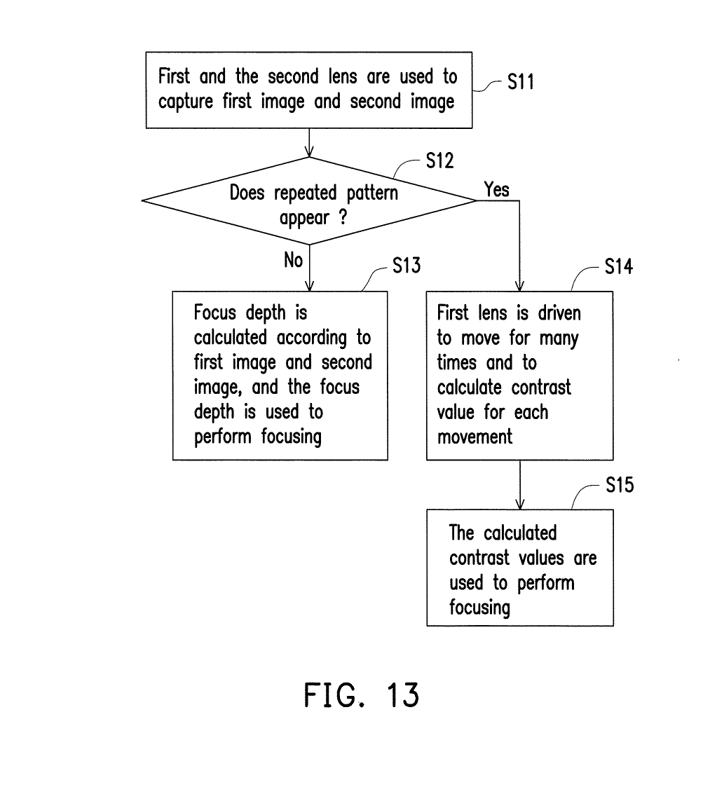

Please refer to FIG. 13 which is a flow diagram of one embodiment of the auto focus method using multiple lenses of the present disclosure. The first embodiment is illustrated by cooperating with the auto focus apparatus 100 of the FIG. 11. The auto focus method comprises following steps.

In step S11, the first lens 20 and the second lens 30 are used to capture a first image 21 and a second image 31, respectively. In step S12, it is judged whether a repeated pattern 42 appears in a preset focus area 41 of the first image 21 and the second image 31. In implementation, the preset focus area 41 is located at the central area of the first image 21 and the second image 31.

In step S13, when it is judged that the repeated pattern 42 does not appear, a focus depth 51 is calculated according to the first image 21 and the second image 31, and according to the focus depth 51 the focusing position control module 130 are respectively controlled to drive movements of the first lens 20 and the second lens 30 for focusing. In step S14, when it is judged that the repeated pattern 42 appears, the first lens 20 is driven to move for many times, and after each of movements, contrast values 61 of the first image 21 captured are calculated. In step S15, according to the calculated contrast values 61, the focusing position control module 130 is respectively controlled to drive movements of the first lens 20 and the second lens 30 for focusing.

In implementation, a contrast value curve 62 is generated according to the contrast values, and a position corresponding to the maximum value in the contrast value curve 62 is used as the focus position 63. The first lens 20 and/or the second lens 30 are driven to move to the focus position 63 for the focusing.

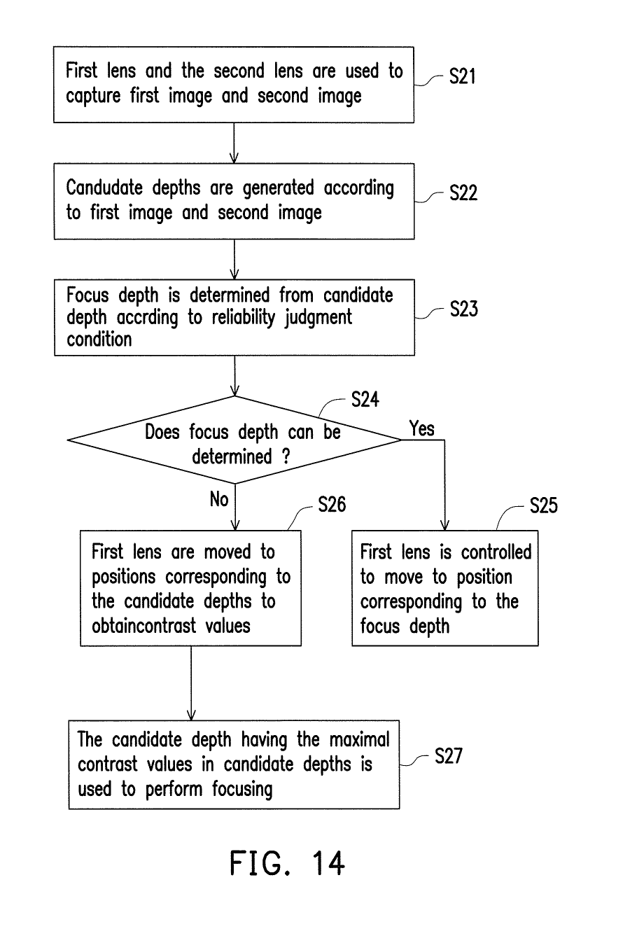

Please refer to FIG. 14 which is a flow diagram of one embodiment of the auto focus method using multiple lenses of the present disclosure. The embodiment is illustrated by cooperating with the auto focus apparatus of the FIG. 12. The auto focus method comprises following steps.

In step S21, the first lens 20 and the second lens 30 are used to capture a first image 21 and a second image 31, respectively. In step S22, a plurality of candidate depths 52 are generated according to a preset focus area 41 of the first image 21 and the second image 31. Each candidate depth 52 has a reliability value 55.

In step S23, a focus depth 51 is determined from the candidate depths 52 according to a reliability judgment condition 54 and a plurality of reliability values 55. It is also judged whether the focus depth 51 can be determined in step S23. If the focus depth 51 can be determined, the step S25 is executed to control the focusing position control module 130 to respectively drive the first lens 20 and the second lens 30 to move to a position corresponding to the focus depth 51.

When the focus depth 51 cannot be determined, the step S26 is executed to control the focusing position control module 130 to respectively drive the first lens 20 or the second lens 30 to move to positions corresponding to the candidate depths 52, and respectively obtain a plurality of contrast values 61. Next, in step S27, the first lens 20 are driven to move to a position corresponding to a candidate depth 52 having the maximal contrast value 61 in the candidate depths 52.

It will be apparent to those skilled in the art that various modifications and variations can be made to the structure of the disclosure without departing from the scope or spirit of the invention. In view of the foregoing, it is intended that the disclosure cover modifications and variations of this invention provided they fall within the scope of the following claims and their equivalents.

What is claimed is:

1. An auto focus (AF) method, adapted to an AF apparatus, wherein the AF apparatus comprises a first image sensor and a second image sensor, the AF method comprising:
capturing a first image by using the first image sensor;
detecting at least one characteristic based on the first image, and determining whether the characteristic meets a predetermined condition;
if the characteristic meets the predetermined condition, calculating a focus depth according to a three-dimensional (3D) depth information and driving movement of a first lens of the first sensor according to the focus depth for focusing; and
if the characteristic does not meet the predetermined condition, driving the first lens to move for many times to obtain a plurality of contrast values, so as to drive movement of the first lens according to the contrast values for focusing.

2. The AF method as claimed in claim 1, wherein the step of detecting the characteristic based on the first image, and determining whether the characteristic meets the predetermined condition comprises:
calculating a brightness reference value of the first image; and
determining whether the brightness reference value is within a predetermined range, wherein the characteristic meets the predetermined condition if the brightness reference value is within the predetermined range, and the characteristic does not meet the predetermined condition if the brightness reference value is not within the predetermined range.

3. The AF method as claimed in claim 1, wherein the step of detecting the characteristic based on the first image, and determining whether the characteristic meets the predetermined condition comprises:
detecting whether a repeated pattern appears in the first image, wherein the characteristic meets the predetermined condition if the repeated pattern does not appear in the first image, and
the characteristic does not meet the predetermined condition if the repeated pattern appears in the first image.

4. The AF method as claimed in claim 1, wherein the step of detecting the characteristic based on the first image, and determining whether the characteristic meets the predetermined condition comprises:
performing a texture detection procedure on the first image to obtain texture information; and
determining whether the first image lacks texture characteristic according to the texture information, wherein the characteristic meets the predetermined condition if the first image does not lack texture characteristic, and the characteristic does not meet the predetermined condition if the first image lacks texture characteristic.

5. The AF method as claimed in claim 1, wherein the step of calculating the focus depth according to the 3D depth information and driving movement of a first lens of the first sensor according to the focus depth for focusing comprises:
capturing a second image by using the second image sensor;
performing a 3D depth estimation according to the first image and the second image to generate a 3D depth map; and
determining the 3D depth information corresponding to a target object according to the 3D depth map, and obtaining the focus depth regarding the target object according to the 3D depth information.

6. The AF method as claimed in claim 5, wherein the step of obtaining the focus depth regarding the target object according to the 3D depth information comprises:
inquiring a depth table according to the 3D depth information to obtain the focus depth regarding the target object.

7. The AF method as claimed in claim 1, further comprises:
capturing a second image by using the second image sensor;
determining whether the first image and the second image are low-correlated with each other based on image capturing information of the first image and the second image or performing feature detection on the first image and the second image; and
if the first image and the second image are low-correlated with each other, driving the first lens to move for many times to obtain the contrast values, so as to driving the movement of the first lens according to the contrast values for focusing.

8. The AF method as claimed in claim 1, wherein the step of driving the first lens to move for many times to obtain a plurality of contrast values, so as to drive movement of the first lens according to the contrast values for focusing comprises:
generating a contrast value curve according to the plurality of contrast values, and the position corresponding to the maximum value of the contrast value curve is used as a focus position; and
controlling the first lens to move to the focus position for focusing.

9. An auto focus (AF) method, adapted to an AF apparatus, wherein the AF apparatus comprises a first image sensor and a second image sensor, the AF method comprising:
capturing a first image and a second image by using the first image sensor and the second image sensor respectively;
calculating a focus depth according to a 3D depth information and driving movement of a first lens of the first sensor according to the focus depth for focusing;
capturing a result image by using the first sensor after the first lens moves based on the focus depth, and determining whether the result image meets a predetermined condition; and
if the result image does not meet the predetermined condition, driving the first lens to move for many times to obtain a plurality of contrast values, so as to drive movement of the first lens according to the contrast values for focusing.

10. The AF method as claimed in claim 8, wherein the step of calculating the focus depth according to the 3D depth information and driving movement of the first lens of the first sensor according to the focus depth for focusing comprises:
performing a 3D depth estimation according to the first image and the second image to generate a 3D depth map; and
determining the 3D depth information corresponding to a target object according to the 3D depth map, and obtaining the focus depth regarding the target object according to the 3D depth information.

11. The AF method as claimed in claim 10, wherein the step of obtaining the focus depth regarding the target object according to the 3D depth information comprises:
inquiring a depth table according to the 3D depth information to obtain the focus depth regarding the target object.

12. The AF method as claimed in claim 10, wherein after the step of performing the 3D depth estimation according to the first image and the second image to generate the 3D depth map, the method further comprises:
checking a reliability level of the 3D depth map according to a plurality of depth values recorded in the 3D depth map;
if the reliability level of the 3D depth map is not greater than a reliability threshold, driving the first lens to move for many times to obtain the contrast values, so as to drive the movement of the first lens according to the contrast values for focusing.

13. The AF method as claimed in claim 10, wherein after the step of performing the 3D depth estimation according to the first image and the second image to generate the 3D depth map, the method further comprises:
performing an optimization process on the 3D depth map to generate an optimized 3D depth map for replacing the 3D depth map.

14. The AF method as claimed in claim 9, wherein the step of determining whether the result image meets a predetermined condition comprises:
estimating a result sharpness level in a focusing frame of the result image, and estimating a absolute sharpness level outside the focusing frame of the result image; and
comparing the result sharpness level in the focusing frame and the absolute sharpness level outside the focusing frame, wherein the result image does not meet the predetermined condition if the absolute sharpness level is greater than the result sharpness level.

15. The AF method as claimed in claim 9, wherein the step of determining whether the result image meets a predetermined condition comprises:
estimating a result sharpness level in a focusing frame of the result image, and estimating a relative sharpness level in the focusing frame of the first image; and
comparing the result sharpness level of the result image and the relative sharpness level of the first image, wherein the result image does not meet the predetermined condition if the relative sharpness level is greater than the result sharpness level.

16. The AF method as claimed in claim 9, further comprising:
detecting at least one characteristic based on the first image, and determining whether the characteristic meets a predetermined condition;
if the characteristic meets the predetermined condition, calculating a focus depth according to a three-dimensional (3D) depth information and driving movement of a first lens of the first sensor according to the focus depth for focusing; and
if the characteristic does not meet the predetermined condition, driving the first lens to move for many times to obtain a plurality of contrast values, so as to driving movement of the first lens according to the contrast values for focusing.

17. An auto focus (AF) apparatus, comprising:
a first image sensor and a second image sensor, photographing a target object to generate a first image and a second image;
a focusing position control module, controlling a focusing position of the first image sensor;
a processing unit, coupled to the first image sensor, the second image sensor, and the focusing position control module, wherein the processing unit is configured for executing:
detecting at least one characteristic based on the first image, and determining whether the characteristic meets a predetermined condition, wherein the processing unit comprises a first focus module and a second focus module,
wherein the first focus module is configured for executing:
if the characteristic meets the predetermined condition, calculating a focus depth according to a three-dimensional (3D) depth information and driving movement of a first lens of the first sensor according to the focus depth for focusing,
wherein the second focus module is configured for executing:
if the characteristic does not meet the predetermined condition, driving the first lens to move for many times to obtain a plurality of contrast values, so as to driving movement of the first lens according to the contrast values for focusing.

18. The AF apparatus as claimed in claim 17, wherein the processing unit is further configured for calculating a brightness reference value of the first image; and
determining whether the brightness reference value is within a predetermined range, wherein the characteristic meets the predetermined condition if the brightness reference value is within the predetermined range, and the characteristic does not meet the predetermined condition if the brightness reference value is not within the predetermined range.

19. The AF apparatus as claimed in claim 17, wherein the processing unit is further configured for detecting whether a repeated pattern appears in the first image, wherein the characteristic meets the predetermined condition if the repeated pattern does not appear in the first image, and the characteristic does not meet the predetermined condition if the repeated pattern appears in the first image.

20. The AF apparatus as claimed in claim 17, wherein the processing unit is further configured for performing a texture detection procedure on the first image to obtain texture information, and determining whether the first image lacks texture characteristic according to the texture information, wherein the characteristic meets the predetermined condition if the first image does not lack texture characteristic, and the characteristic does not meet the predetermined condition if the first image lacks texture characteristic.

21. The AF apparatus as claimed in claim 17, wherein the first focus module is further configured for performing a 3D depth estimation according to the first image and the second image to generate a 3D depth map, determining the 3D depth information corresponding to a target object according to the 3D depth map, and obtaining the focus depth regarding the target object according to the 3D depth information.

22. The AF apparatus as claimed in claim 21, further comprising:.
a storage unit, coupled to the processing unit, and configured to store the first image, the second image, and a depth table,
wherein the first focus module is further configured for inquiring the depth table according to the 3D depth information to obtain the focus depth regarding the target object.

23. The AF apparatus as claimed in claim 17, wherein the processing unit is further configured for determining whether the first image and the second image are low-correlated with each other based on image capturing information of the first image and the second image or performing feature detection on the first image and the second image,
wherein if the first image and the second image are low-correlated with each other, the second focus module is further configured for driving the first lens to move for many times to obtain the contrast values, so as to drive the movement of the first lens according to the contrast values for focusing.

24. The AF apparatus as claimed in claim 17, wherein the second focus module is further configured for generating a contrast value curve according to the plurality of contrast values; and controlling the first lens to move to the focus position for focusing, wherein the position corresponding to the maximum value of the contrast value curve is used as a focus position.

25. An auto focus (AF) apparatus, comprising:
a first image sensor and a second image sensor, photographing a target object to generate a first image and a second image;
a focusing position control module, controlling a focusing position of the first image sensor;
a processing unit, coupled to the first image sensor, the second image sensor, and the focusing position control module, wherein the processing unit comprises a first focus module and a second focus module,
wherein the first focus module is configured for executing:
calculating a focus depth according to a 3D depth information and driving movement of a first lens of the first sensor according to the focus depth for focusing,
wherein the processing unit is configured for executing:
capturing a result image by using the first sensor after the first lens moves based on the focus depth, and determining whether the result image meets a predetermined condition,
wherein the second focus module is configured for executing:
if the result image does not meet the predetermined condition, driving the first lens to move for many times to obtain a plurality of contrast values, so as to drive movement of the first lens according to the contrast values for focusing.

26. The AF apparatus as claimed in claim 25, wherein the first focus module is further configured for performing a 3D depth estimation according to the first image and the second image to generate a 3D depth map, and determining the 3D depth information corresponding to a target object according to the 3D depth map, and obtaining the focus depth regarding the target object according to the 3D depth information.

27. The AF apparatus as claimed in claim 26, further comprising:
a storage unit, coupled to the processing unit, and configured to store the first image, the second image, and a depth table,
wherein the first focus module is further configured for inquiring the depth table according to the 3D depth information to obtain the focus depth regarding the target object.

28. The AF apparatus as claimed in claim 26, wherein the first focus module is further configured for checking a reliability level of the 3D depth map according to a plurality of depth values recorded in the 3D depth map,
wherein if the reliability level of the 3D depth map is not greater than a reliability threshold, the second focus module is further configured for driving the first lens to move for many times to obtain the contrast values, so as to drive the movement of the first lens according to the contrast values for focusing.

29. The AF apparatus as claimed in claim 26, wherein the first focus module is further configured for performing an optimization process on the 3D depth map to generate an optimized 3D depth map for replacing the 3D depth map.

30. The AF apparatus as claimed in claim 25, wherein the processing unit is further configured for estimating a result sharpness level in a focusing frame of the result image, and estimating a absolute sharpness level outside the focusing frame of the result image, and comparing the result sharpness level in the focusing frame and the absolute sharpness level outside the focusing frame, wherein the result image does not meet the predetermined condition if the absolute sharpness level is greater than the result sharpness level.

31. The AF apparatus as claimed in claim 25, wherein the processing unit is further configured for estimating a result sharpness level in a focusing frame of the result image, and estimating a relative sharpness level in the focusing frame of the first image, and comparing the result sharpness level of the result image and the relative sharpness level of the first image, wherein the result image does not meet the predetermined condition if the relative sharpness level is greater than the result sharpness level.

32. The AF apparatus as claimed in claim 25, wherein the processing unit is further configured for detecting at least one characteristic based on the first image, and determining whether the characteristic meets a predetermined condition,
wherein if the characteristic meets the predetermined condition, the first focus module is further configured for calculating a focus depth according to a three-dimensional (3D) depth information and driving movement of a first lens of the first sensor according to the focus depth for focusing,
wherein if the characteristic does not meet the predetermined condition, the second focus module is further configured for driving the first lens to move for many times to obtain a plurality of contrast values, so as to .driving movement of the first lens according to the contrast values for focusing.
